(19) United States
(12) Patent Application Publication
(10) Pub. No.: US 2019/0197469 A1
(43) Pub. Date: Jun. 27, 2019

(54) Seal Printing System

(71) Applicant: Walmart Apollo, LLC, Bentonville, AR (US)

(72) Inventors: Andrew B. Millhouse, Gilbert, AZ (US); John S. Meredith, Bentonville, AR (US); Timothy J. Burleson, Bentonville, AR (US)

(21) Appl. No.: 16/191,370

(22) Filed: Nov. 14, 2018

Related U.S. Application Data
(60) Provisional application No. 62/610,466, filed on Dec. 26, 2017.

(51) Int. Cl. G06Q 10/08; B29C 64/393; B33Y 10/00; B33Y 50/02; B33Y 30/00

(52) U.S. Cl. CPC G06Q 10/0833; B29C 64/393; B33Y 30/00; B33Y 50/02; B33Y 10/00

(57) ABSTRACT

A seal printing system including a three-dimensional printer and a seal blank is described. The seal blank has a non-functioning structure. The non-functioning structure includes a first completed end and an uncompleted end incapable of interlocking with each other. The printer is configured to receive the seal blank having the non-functioning structure. The printer is configured to print a second completed end of the seal blank. The second completed end is connected to the uncompleted end such that the first and second completed ends are capable of interlocking.

### CROSS-REFERENCE TO RELATED APPLICATIONS

This application claims the benefit of co-pending, commonly assigned U.S. Provisional Patent Application No. 62/610,466, which was filed on Dec. 26, 2017. The entire content of the foregoing provisional patent application is incorporated herein by reference.

### BACKGROUND

A seal having a unique serial number printed or embossed thereon is generally used to lock a truck trailer prior to leaving a loading bay so that any subsequent opening of the trailer may be detected. The serial number is copied from the seal into a logbook to associate the seal with the specific truck trailer. If the truck makes multiple delivery stops, the seal is broken to unload some of the load, and a new seal having a different serial number is used to reseal the truck trailer. The serial number of the new seal must also be copied into a logbook to maintain accurate delivery documentation.

### SUMMARY

Exemplary embodiments of the present invention provide seal printing systems including a three-dimensional (3D) printer and a seal blank having a non-functioning structure. The ends of the seal blank having the non-functioning structure are incapable of being interlocked until the 3D printer prints a completed end. The 3D printer is therefore capable of receiving the seal blank having the non-functioning structure, and is able to print a completed end to output the seal blank having a functioning structure such that the ends can be interlocked. The 3D printer can embed and/or activate a radio-frequency identification (RFID) chip during the printing process, and can print and/or emboss a unique serial number on the seal blank. The 3D printer may also be configured to encode an RFID chip already in a blank seal with information associated with a shipment. The 3D printer can be configured to print the completed end only when confirmation is received that all items have been loaded into the truck trailer to prevent early locking of the truck trailer. The 3D printer can be used to print and/or emboss the same serial number on seals for one truck during multiple delivery stops, allowing a single serial number to be used for one truck during the delivery route.

In one embodiment, an exemplary seal printing system is provided. The seal printing system includes a 3D printer and a seal blank having a non-functioning structure. The non-functioning structure includes a first completed end and an uncompleted end incapable of interlocking with each other. The 3D printer is configured to receive the seal blank having the non-functioning structure. The 3D printer is configured to print a second completed end of the seal blank. The second completed end is connected to the uncompleted end such that the first and second completed ends are capable of interlocking.

In another embodiment, an exemplary 3D seal printer is provided. The 3D printer includes an input, a jig, one or more sensors, and a printing section. The input can be configured to receive a seal blank having a non-functioning structure. The non-functioning structure includes a first completed end and an uncompleted end incapable of interlocking with each other. The jig can be configured to maintain the seal blank in a predetermined orientation and position. The one or more sensors can be configured to detect one or more edges of the seal blank. The printing section can be configured to print a second completed end of the seal blank. The second completed end is connected to the uncompleted end such that the first and second completed ends are capable of interlocking.

In another embodiment, an exemplary method of seal printing is provided. The method includes introducing a blank seal into a 3D printer. The seal blank has a non-functioning structure including a first completed end and an uncompleted end incapable of interlocking with each other. The method includes receiving input data corresponding to shipment information at a computing system having a user interface. The computing system is in communication with the 3D printer. The method includes receiving input confirmation of complete entry of the shipment information into the computing system. The method includes transmitting an indication of the confirmation from the computing system to the 3D printer. The method includes initiating printing of a second completed end of the seal blank based on the confirmation. The second completed end connected to the uncompleted end such that the first and second completed ends are capable of interlocking.

It should be appreciated that other combinations and/or permutations of embodiments are envisioned as also being within the scope of the present invention. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed seal printing systems and methods, reference is made to the accompanying figures. The accompanying figures, which are incorporated in and constitute a part of this specification, illustrate one or more embodiments of the invention and, together with the description, help to explain the invention. In the figures:

FIG. 1 is a block diagram of an exemplary seal printing system in an embodiment.

FIG. 2A is a diagrammatic top view of seal blanks of an exemplary seal printing system in an embodiment, the seal blanks having a non-functioning structure including a first completed end and an uncompleted end.

FIG. 2B is a diagrammatic top view of seal blanks of an exemplary seal printing system in an embodiment, the seal blanks having a functioning structure including first and second completed ends, and a unique identifier number.

FIG. 2C is a diagrammatic top view of seal blanks of an exemplary seal printing system in an embodiment, the seal blanks having a functioning structure including first and second completed ends, and an RFID chip.

FIG. 2D is a diagrammatic top view of seal blanks of an exemplary seal printing system in an embodiment, the seal blanks having a functioning structure including first and second completed ends, a unique identifier number, and an RFID chip.

FIG. 3 is a block diagram of a computing device in an embodiment.

FIG. 4 is a block diagram of a seal printing system environment in an embodiment.

FIG. 5 is a flowchart illustrating an implementation of a seal printing system in an embodiment.

FIG. 6 is a flowchart illustrating an implementation of a seal printing system in an embodiment.

### DETAILED DESCRIPTION

It should be understood that certain relative terminology used herein, such as, but not necessarily limited to, “front”, “rear”, “left”, “top”, “bottom”, “vertical”, “horizontal”, “up” and “down” is solely for the purposes of clarity and designation and is not intended to limit embodiments to a particular position and/or orientation. Accordingly, such relative terminology should not be construed to limit the scope of the present disclosure. In addition, it should be understood that the scope of the present disclosure is not limited to embodiments having specific dimensions. Thus, any dimensions provided herein are for an exemplary purpose and are not intended to limit the invention to embodiments having particular dimensions.

Traditional sealing of truck trailers prior to and during multiple delivery stops involves using new seals having different serial numbers printed or embossed thereon. Each time a new seal is placed on the truck trailer, the serial number for the seal is copied into a logbook to maintain accurate delivery documentation. Such copying of the serial number can be time consuming and can lead to mistakes in notation of the serial number. If a truck trailer is improperly locked with the seal prior to loading of all items, the seal is broken and a new seal must be used. Because each seal has a unique serial number, if multiple deliveries are made by a single truck, using multiple different seals with different serial numbers complicates the delivery documentation process.

Exemplary embodiments of the present invention address these concerns and provide a seal printing system that includes a three-dimensional printer and a seal blank. More particularly, the exemplary seal printing system allows for a seal blank having a non-functioning structure to be introduced into the three-dimensional printer, and the three-dimensional printer prints a completed end of the seal blank such that the opposing ends of the seal blank can be interlocked (e.g., a functioning structure). The three-dimensional printer can embed and/or activate a radio-frequency identification chip in the seal blank, and can print and/or emboss a serial number on the seal during printing of the completed end. The three-dimensional printer can be configured to print the completed end only when confirmation is received that all items have been loaded into the truck trailer, and the same serial number can be used or reprinted by the three-dimensional printer even when multiple deliveries are made along a route. In one embodiment, the three-dimensional printer may encode an RFID chip in the seal blank with information associated with the items loaded into the trailer.

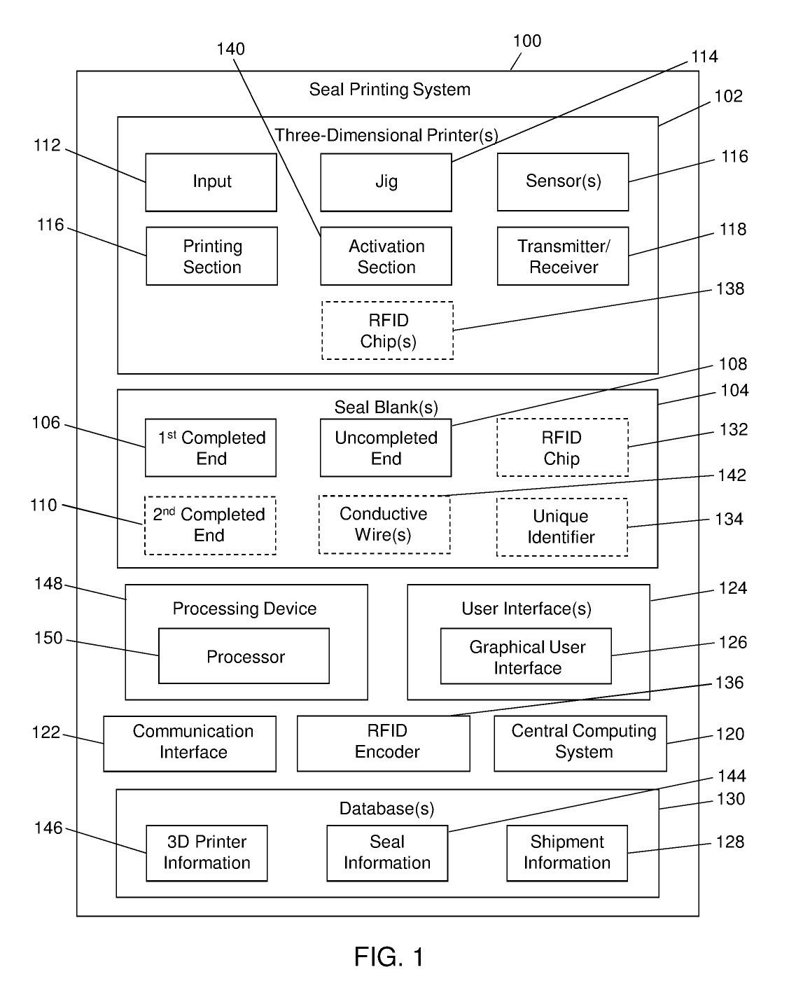

FIG. 1 is a block diagram of a seal printing system 100 (hereinafter “system 100”) in accordance with exemplary embodiments. The system 100 includes one or more three-dimensional (3D) printers 102 each configured to receive one or more seal blanks 104. In some embodiments, 3D printers 102 can be located at the loading location where items are loaded onto a truck prior to initiation of a delivery route, at each drop-off location where one or more items are delivered, and at a final location where the empty truck is stored prior to further deliveries being made. In some embodiments, 3D printers 102 can be located at each location where the truck trailer is to be sealed, whether upon initial loading of items into the truck trailer or at each delivery location along the delivery route. By having the 3D printers 102 at different locations along the delivery route, seal blanks 104 can be completed on-site and in real-time as needed. Similarly, in one embodiment, the three-dimensional printer may be portable such that it can be located in the truck to allow printing of a new seal as instructed by a central computing system without having to pre-position the printer in a certain location. Accordingly, rather than using pre-marked seals, the system 100 allows for customized seal blanks 104 to be printed as needed.

Each seal blank 104 is initially presented to the 3D printer in a non-functioning structure. Particularly, each seal blank 104 defines a substantially elongated structure or body with a first completed end 106 and an opposing uncompleted end 108. As used herein, a non-functioning structure of the seal blank 104 refers to the inability of the first completed end 106 and the uncompleted end 108 from mechanically interlocking with each other due to missing structural components. In some embodiments, the uncompleted end 108 of the seal blank 104 can include one or more perforations and/or grooves formed therein. As will be discussed below, the 3D printer 102 prints a second completed end at least partially onto the uncompleted end 108 to create a functioning structure of the seal blank 104, the perforations and/or grooves ensuring a secure connection of the second completed end to the uncompleted end 108. As used herein, a functioning structure of the seal blank 104 refers to the ability of the first completed end 106 and the second completed end 110 to mechanically interlock with each other.

The 3D printer 102 includes an input 112 configured to receive the seal blank 104 having the non-functioning structure of the first completed end 106 and the uncompleted end 108. In some embodiments, the 3D printer 102 is capable of receiving multiple seal blanks 104 within a tray such that a single seal blank 104 can be fed by the 3D printer 102 to a jig 114 for printing. In some embodiments, the 3D printer 102 can receive a single seal blank 104 individually each time, and outputs a request for input of the seal blank 104 when ready to print. The jig 114 receives the seal blank 104 from the input 112 and maintains the seal blank 104 in a predetermined orientation and position for printing. The jig 114 therefore ensures that the second completed end 110 is properly printed and connected to the uncompleted end 108 of the seal blank 104.

The 3D printer 102 includes one or more sensors 116 configured to detect one or more edges of the seal blank 104. For example, the sensors 116 can be optical, mechanical, combinations thereof, or the like. Detection with the sensors 116 allows the 3D printer 102 to accurately print the second completed end 110. The 3D printer 102 includes a printing section 116 configured to print the second completed end 110 of the seal blank 104. In some embodiments, the second completed end 110 can be printed to partially overlap the uncompleted end 108 and extend from the uncompleted end 108 to form the second completed end 110 that is capable of interlocking with the first completed end 106. In some embodiments, the second completed end 110 can be fused directly to the edge of the uncompleted end 108 without overlapping the uncompleted end 108.

The 3D printer 102 can include a transmitter/receiver 118 configured to receive data from a central computing system 120 via a communication interface 122 (e.g., a wired and/or wireless network). The communication interface 122 therefore communicatively couples the central computing system 120 to the 3D printer 102. For example, the system 100 (and/or the 3D printer 102) can include one or more user interfaces 124 having a graphical user interface (GUI) 126 for input and output of data into/from the system 100. Such data can include shipment information 128 (e.g., tracking number, destination name, items on a pallet, temperature requirements of items, pallet weight, combinations thereof, or the like) entered into the central computing system 120 and electronically stored in one or more databases 130. The system 100 can include a processing device 148 with a processor 150 for processing the data received by the central computing system 120. In some embodiments, the processing device 148 can be a component of the central computing system 120.

In some embodiments, the 3D printer 102 is configured to only initiate printing of the second completed end 110 of the seal blank 104 upon receiving confirmation of a complete entry of the shipment information 128 into the central computing system 120. Particularly, the shipment information 128 can confirm that all necessary items for delivery have been loaded into the truck trailer, and the truck trailer is ready to be sealed. Upon entry of such confirmation into the central computing system 120, the confirmation can be electronically transmitted to the transmitter/receiver 118 of the 3D printer 102, and the printing section 116 can initiate printing of the second completed end 110. In some embodiments, printing of the seal blank 104 can be initiated, but not completed, before such confirmation is received by the central computing system 120 in preparation for shipment.

In some embodiments, the 3D printer 102 prints only the second completed end 110 of the seal blank 104 and outputs the seal blank 104 for locking the truck trailer. In such embodiments, the seal blank 104 can already include embedded therein a radio-frequency identification (RFID) chip 132 and/or printed or embossed thereon a unique numerical or alphanumerical identifier (e.g., a serial number). In such embodiments, the system 100 (and/or the 3D printer 102) can include an RFID encoder 136 for encoding the RFID chip 132. An activation section 140 of the 3D printer 102 can activate the RFID chip 132.

In some embodiments, the seal blank 104 can be provided without the RFID chip 132 and the 3D printer 102 can include one or more RFID chips 138. During, before and/or after printing the second completed end 110, the 3D printer 102 can embed the RFID chip 138 into the seal blank 104. In such embodiments, the activation section 140 of the 3D printer 102 can be configured to activate the RFID chip 138 embedded into the seal blank 104 (e.g., the second completed end 110 of the seal blank 104). The system 100 (and/or the 3D printer 102) can include the RFID encoder 136 for encoding the RFID chip 138). In some embodiments, the RFID chip 132, 138 can be configured to output a radio-frequency signal at all times or at preset frequencies.

In some embodiments, the RFID chip 132, 138 and/or the seal blank 104 can include one or more conductive wires 142 connected to the RFID chip 132, 138 such that breaking of the seal blank 104 during opening of the truck trailer stops an electrical connection and transmits a radio-frequency signal from the RFID chip 132, 138, acting as a security feature for the seal blank 104. Such signal can be transmitted to the central computing system 120, indicating the geographic location, day and time of breakage of the seal blank 102 (e.g., after the first and second completed ends 106, 110 have been interlocked and subsequently broken). The data relating to breakage of the seal blank 102 can be transmitted to and stored within the database 130 as shipment information 128. In some embodiments, the seal blank 104 can allow the RFID chip 132, 138 to transmit RF signals only when the conductive wires 142 are intact.

In some embodiments, the 3D printer 102 can be configured to print and/or emboss a unique numerical and/or alphanumerical identifier 134 on the seal blank 104 before, during or after printing of the second completed end 110. In some embodiments, the unique identifier 134 can be a QR code or barcode. In such embodiments, upon generating and printing the unique identifier 134, the 3D printer 102 can transmit the unique identifier 134 information to the central computing system 120 via the communication interface 122, and such data can be electronically stored as seal information 144 in the database 130. The seal information 144 can be correlated with the shipment information 128 for proper delivery chain tracking.

In some embodiments, the 3D printer 102 can be configured to print at least some of the input data (e.g., shipment information 128) on the seal blank 104 during printing of the second completed end 110. For example, the 3D printer 102 can print the destination or temperature requirements for the shipment. Alternatively, in another embodiment, instead of the shipment information being manually printed on the seal blank 104, it may be encoded into an RFID chip in the seal blank 104. In some embodiments, the database 130 can electronically store 3D printer information 146 (e.g., printer locations, printer identifiers, seals printed at each printer, combinations thereof, or the like).

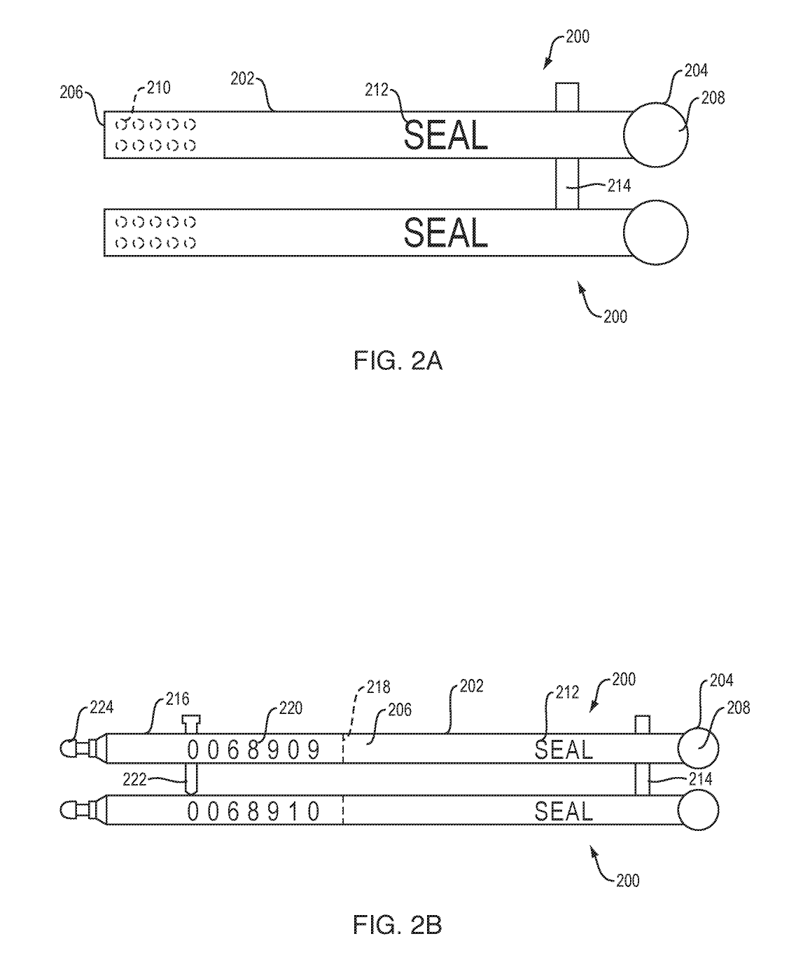

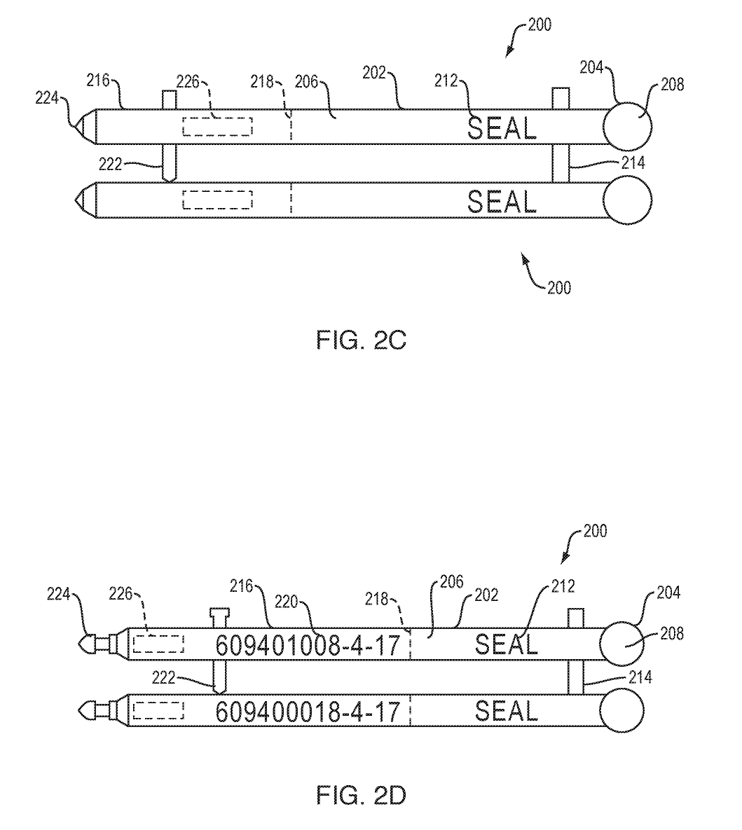

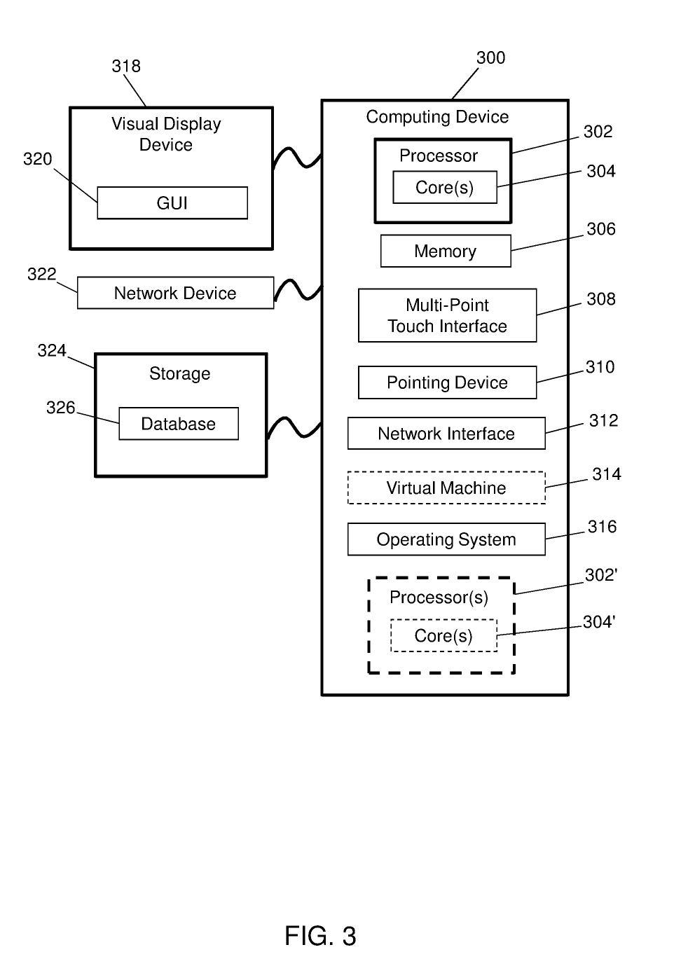

FIG. 2A is a diagrammatic top view of exemplary seal blanks 200 having a non-functioning structure. Each seal blank 200 includes an elongated body 202 with a first completed end 204 and an uncompleted end 206. The seal blank 200 can be formed from a plastic, flexible material that allows the elongated body 202 to be bent. In the non-functioning configuration, the first completed end 204 is structurally incapable of interlocking with the uncompleted end 206. In some embodiments, the completed end 204 can include an opening 208 passing therethrough such that once printed, the second completed end can be passed through the opening 208 to interlock the first completed end 204 and the second completed end.

The uncompleted end 206 can include one or more perforations and/or grooves 210 formed therein. The perforations and/or grooves 210 can assist in providing a gripping surface for the material printed by the 3D printer when forming the second completed end. For example, the 3D printer can partially overlap the second completed end with the uncompleted end 206, with the perforations and/or grooves 210 providing a secure junction between the two ends. In some embodiments, the body 202 of the seal blank 200 can include one or more notations 212 thereon. In some embodiments, such notations 212 can be generic notations, such as a logo or name, with the shipment-specific information being printed on the second completed end by the 3D printer. Alternatively, as noted above, the shipment-specific information may be encoded into an RFID chip in the seal blank 200. In some embodiments, multiple seal blanks 200 can be connected to each other by detachably or breakable connectors 214.

FIG. 2B is a diagrammatic top view of the seal blank 200 having a functioning structure (e.g., after the 3D printer has printed a second completed end 216). Particularly, the 3D printer can print the second completed end 216 such that the second completed end 216 is structurally connected to the uncompleted end 206. A joint 218 is formed between the second completed end 216 and the uncompleted end 206. In some embodiments, the second completed end 216 can at least partially overlap the uncompleted end 206. In some embodiments, the 3D printer creates the structural joint 218 directly between the second completed end 216 and the uncompleted end 206 with no or minimal overlap between the ends 206, 216. The second completed end 216 extends from the joint 218 away from the uncompleted end 206 and substantially parallel and in-line with the body 202.

After or during printing of the second completed end 216, the 3D printer can print and/or emboss a unique identifier 220 (e.g., a serial number) on the second completed end 216. In some embodiments, the 3D printer can print detachable connectors 222 for connecting adjacently disposed second completed ends 216. In some embodiments, the second completed end 216 can include a tip 224 having a width or diameter smaller than the body 202 and the majority of the second completed end 216. The tip 224 can assist in inserting and feeding the second completed end 216 through the opening 208 of the first completed end 204 for interlocking of the ends 204, 216.

FIG. 2C is a diagrammatic top view of seal blanks 200 having a functioning structure. In some embodiments, during printing of the second completed end 216, the 3D printer can embed, encode and activate an RFID chip 226. Thus, rather than including a unique identifier 220, the seal blank 200 can include only an RFID chip 226 with signals used to identify the shipment information associated with the seal blank 200. In some embodiments, the body 202 can include an RFID chip similar to the RFID chip 226, and the 3D printer can activate the RFID chip in the body 202 without embedded another RFID chip 226 in the second completed end 216.

FIG. 2D is a diagrammatic top view of seal blanks 200 having a functioning structure. In some embodiments, the 3D printer can emboss and/or print a unique identifier 220 on the second completed end, and also embeds, encodes and activates an RFID chip 226 in the second completed end. Both visual and RF signal identifications can thereby be provided by the 3D printer. In some embodiments, the 3D printer can be configured to print the tip 224 and/or the unique identifier 220 in a different color from the body of the second completed end 216, providing a clear contrast between the body and any relevant information. In some embodiments, the colors used by the 3D printer can indicate the type of product or category of products in the shipment. In some embodiments, a seal blank 200 having a functioning structure can be input directly into the 3D printer. In such embodiments, rather than printing the second completed end 216, the 3D printer can only be used for embossing or printing the unique identifier 220 and embedding and/or encoding and/or activating the RFID chip 226.

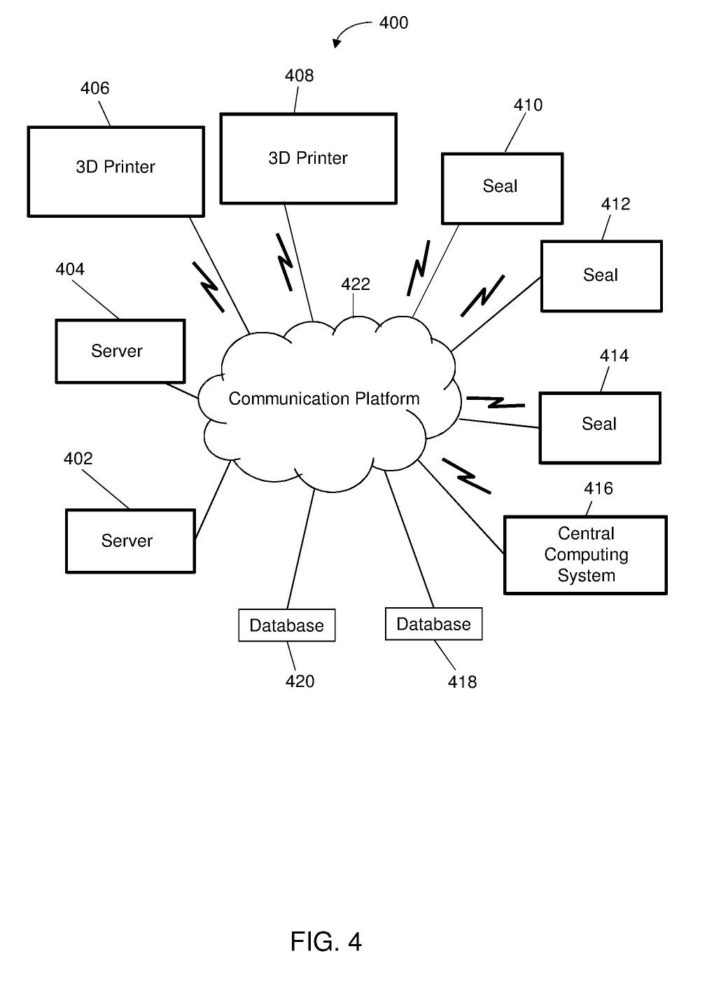

FIG. 3 is a block diagram of a computing device 300 in accordance with exemplary embodiments. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 306 included in the computing device 300 may store computer-readable and computer-executable instructions or software for implementing exemplary embodiments of the present disclosure (e.g., instructions for controlling the 3D printer 102, the user interface 124, the processing device 148, the communication interface 120, the RFID encoder 136, the central computer system 120, combinations thereof, or the like). The computing device 300 also includes configurable and/or programmable processor 302 and associated core 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for controlling system hardware. Processor 302 and processor(s) 302′ may each be a single core processor or multiple core (304 and 304′) processor.

Virtualization may be employed in the computing device 300 so that infrastructure and resources in the computing device 300 may be shared dynamically. A virtual machine 314 may be provided to handle a process running on multiple processors so that the process appears to be using only one computing resource rather than multiple computing resources. Multiple virtual machines may also be used with one processor. Memory 306 may include a computer system memory or random access memory, such as DRAM, SRAM, EDO RAM, and the like. Memory 306 may include other types of memory as well, or combinations thereof.

A user may interact with the computing device 300 through a visual display device 318 (e.g., a personal computer, a mobile smart device, or the like), such as a computer monitor, which may display one or more user interfaces 320 (e.g., GUI 126) that may be provided in accordance with exemplary embodiments. The computing device 300 may include other I/O devices for receiving input from a user, for example, a keyboard or any suitable multi-point touch interface 308, a pointing device 310 (e.g., a mouse). The keyboard 308 and the pointing device 310 may be coupled to the visual display device 318. The computing device 300 may include other suitable conventional I/O peripherals.

The computing device 300 may also include one or more storage devices 324, such as a hard-drive, CD-ROM, or other computer readable media, for storing data and computer-readable instructions and/or software that implement one or more portions of the system 100, such as the 3D printer 102, the processing device 148, the user interface 124, the communication interface 122, the RFID encoder 136, the central computing system 120, or the like. Exemplary storage device 324 may also store one or more databases 326 for storing any suitable information required to implement exemplary embodiments. For example, exemplary storage device 324 can store one or more databases 326 for storing information, such as data relating to the 3D printer information 146, the seal information 144, the shipment information 128, or the like, and computer-readable instructions and/or software that implement exemplary embodiments described herein. The databases 326 may be updated by manually or automatically at any suitable time to add, delete, and/or update one or more items in the databases.

The computing device 300 can include a network interface 312 configured to interface via one or more network devices 322 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 312 may include a built-in network adapter, network interface card, PCMCIA network card, card bus network adapter, wireless network adapter, USB network adapter, modem or any other device suitable for interfacing the computing device 300 to any type of network capable of communication and performing the operations described herein. Moreover, the computing device 300 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 300 may run an operating system 316, such as versions of the Microsoft® Windows® operating systems, the different releases of the Unix and Linux operating systems, versions of the MacOS® for Macintosh computers, embedded operating systems, real-time operating systems, open source operating systems, proprietary operating systems, or other operating systems capable of running on the computing device and performing the operations described herein. In exemplary embodiments, the operating system 316 may be run in native mode or emulated mode. In an exemplary embodiment, the operating system 316 may be run on one or more cloud machine instances.

FIG. 4 is a block diagram of an exemplary seal printing system environment 400 in accordance with exemplary embodiments of the present disclosure. The environment 400 can include servers 402, 404 operatively coupled to 3D printers 406, 408, seals 410, 412, 414 (e.g., RFID chips within the seals 410, 412, 414), and central computing system 416, via a communication platform 422, which can be any network over which information can be transmitted between devices communicatively coupled to the network. For example, the communication platform 422 can be the Internet, Intranet, virtual private network (VPN), wide area network (WAN), local area network (LAN), and the like. In an embodiment, the communication platform 422 can be part of a cloud environment.

The environment 400 can include repositories or databases 418, 420, which can be operatively coupled to the servers 402, 404, as well as to the 3D printers 406, 408, seals 410, 412, 414, and central computing system 416, via the communications platform 422. In exemplary embodiments, the servers 402, 404, 3D printers 406, 408, seals 410, 412, 414, and central computing system 416, and databases 418, 420 can be implemented as computing devices (e.g., computing device 300). Those skilled in the art will recognize that the databases 418, 420 can be incorporated into one or more of the servers 402, 404 such that one or more of the servers 402, 404 can include databases 418, 420.

In an embodiment, the databases 418, 420 can store 3D printer information, seal information, and shipment information. In an embodiment, embodiments of the servers 402, 404 can be configured to implement one or more portions of the system 100. For example, server 402 can be configured to implement one or more portions of the 3D printer 102, the processing device 148, the user interface 124, the communication interface 122, the RFID encoder 136, and/or the central computing system 120.

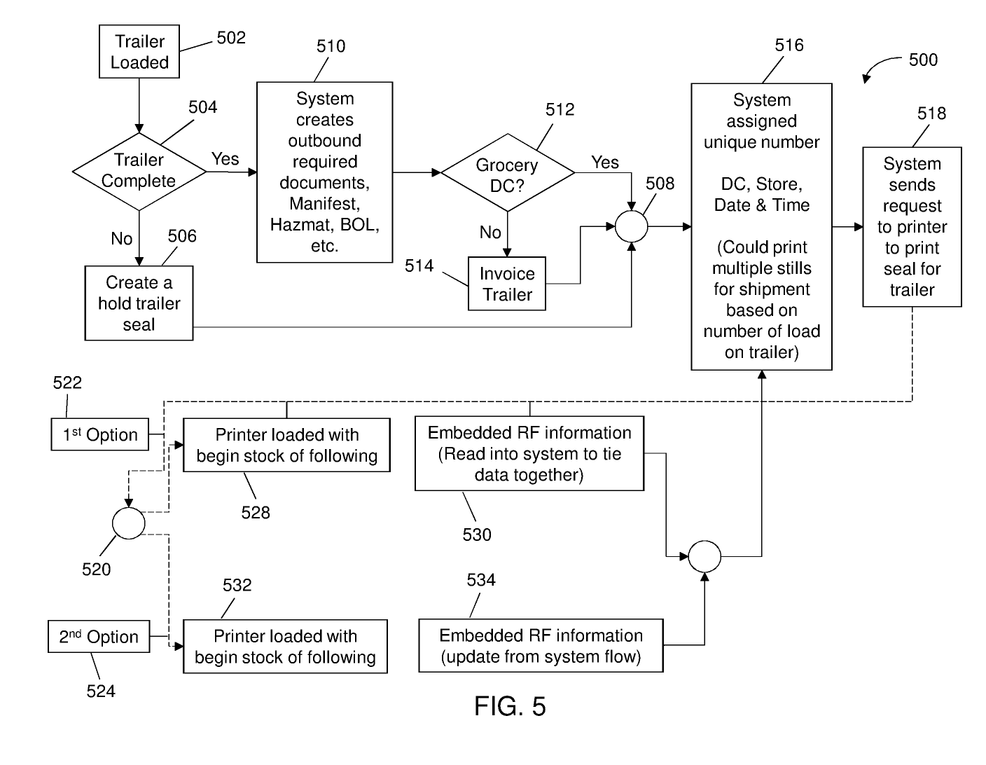

FIG. 5 is a flowchart illustrating an exemplary process 500 as implemented by a seal printing system. To begin, at step 502, a truck trailer is loaded with one or more items to be delivered. At step 504, a determination is made by a central computing system based on input data that loading of the truck trailer is complete. If loading of the truck trailer is not complete, in some embodiments, at step 506, a hold for the trailer seal is created, and the process 500 proceeds to decision point 508.

If at step 504 the system determines that the trailer loading is complete, at step 510, the system can create outbound documents, such as Manifest, Hazmat, bill of landing, or the like. At step 512, a determination is made whether the items are from a grocery distribution center. If no, at step 514, an invoice for the trailer is generated. If yes, the process 500 proceeds to the decision point 508. At step 516, the system assigns a unique identifier number, originating store, distribution center, date, time, combinations thereof, or the like, to the seal blank. In some embodiments, seal blanks can be printed by the 3D printer depending on the number of loads on the trailer.

At step 518, the system transmits a request to the 3D printer to print the seal blank for the particular trailer, and the process 500 accepts (e.g. via a GUI) a selection of a printing option at step 520. In a first printing option 522, the three-dimensional printer prints a seal from a seal blank with a non-functioning structure. If the first printing option 522 is selected, at step 528, the 3D printer is loaded with a seal blank having a non-functioning structure. At step 530, the 3D printer prints the second completed end of the seal blank, embosses or prints the unique identifier on the second completed end, and embeds and/or encodes and/or activates an RFID chip based on the unique identification information obtained at step 516. If a second printing option 524 is selected at step 520, at step 532, the 3D printer is loaded with a seal blank having a functioning structure but without any identifying information. At step 534, the 3D printer prints the unique identifier on the second completed end, and embeds and/or encodes and/or activates an RFID chip for the seal blank based on the unique identification information obtained at step 516.

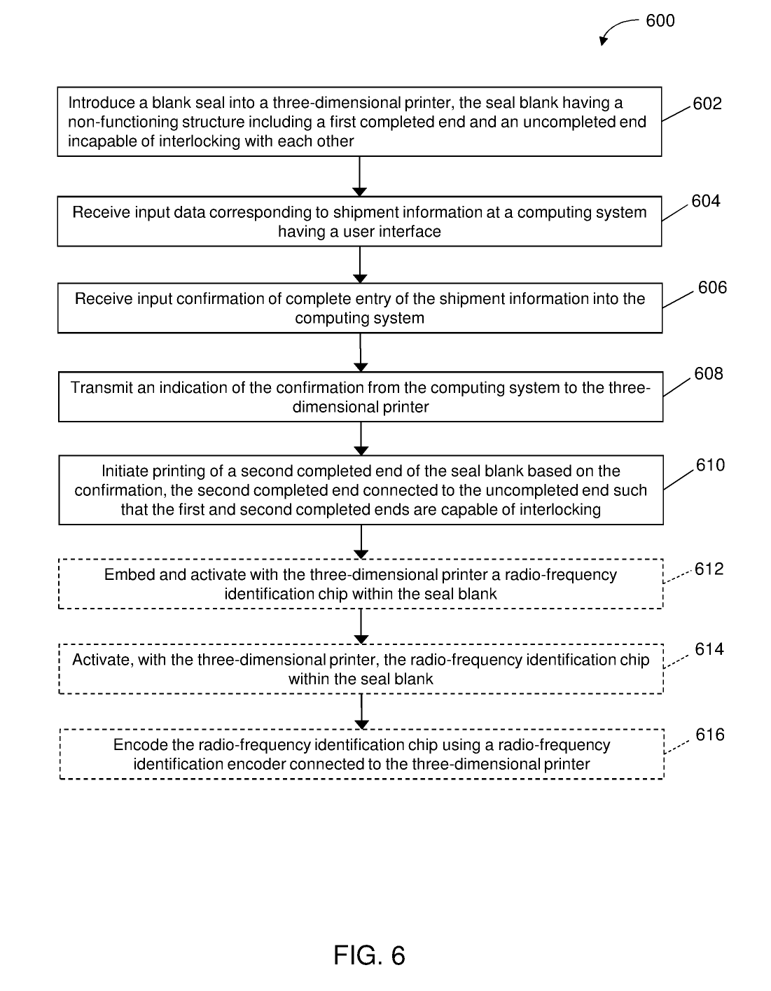

FIG. 6 is a flowchart illustrating an exemplary process 600 as implemented by a seal printing system. To begin, at step 602, a blank seal is introduced into a 3D printer, the blank seal having a non-functioning structure. At step 604, input of data corresponding to shipment information is received at a computing system having a user interface. At step 606, input of confirmation of complete entry of the shipment information is received at the computing system. At step 608, an indication of the confirmation is transmitted from the computing system to the 3D printer.

At step 610, printing of the second completed end of the seal blank is initiated based on the received confirmation of the completion of the entry of shipment information. The second completed end is connected to the uncompleted end of the seal blank such that the first and second completed ends are capable of mechanically interlocking. In some embodiments, at step 612, the 3D printer embeds and activates an RFID chip within the seal blank. In some embodiments, at step 614, the 3D printer activates the RFID chip already located within the seal blank. In some embodiments, at step 616, the RFID chip is encoded using an RFID encoder connected to the 3D printer to include information associated with the shipment.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A seal printing system, comprising:
a three-dimensional printer; and
a seal blank having a non-functioning structure, the non-functioning structure including a first completed end and an uncompleted end incapable of interlocking with each other;
wherein the three-dimensional printer is configured to receive the seal blank having the non-functioning structure, and
wherein the three-dimensional printer is configured to print a second completed end of the seal blank, the second completed end connected to the uncompleted end such that the first and second completed ends are capable of interlocking.

2. The seal printing system of claim 1, wherein the three-dimensional printer is configured to embed and activate a radio-frequency identification chip included within the seal blank.

3. The seal printing system of claim 1, wherein the blank seal includes a radio-frequency identification chip and the three-dimensional printer is configured to activate the radio-frequency identification chip within the seal blank.

4. The seal printing system of claim 1, wherein the seal blank includes one or more conductive wires connected to a radio-frequency identification chip such that breaking of the seal blank after interlocking of the first and second completed ends stops an electrical connection and transmits a signal from the radio-frequency identification chip.

5. The seal printing system of claim 1, wherein the blank seal includes a radio-frequency identification chip and the system further comprises a radio-frequency identification encoder connected to the three-dimensional printer for encoding the radio-frequency identification chip.

6. The seal printing system of claim 1, further comprising:
a computing system providing a user interface configured to receive input data corresponding to shipment information, the computing system communicatively coupled to the three-dimensional printer.

7. The seal printing system of claim 6, wherein the three-dimensional printer is configured to print at least some of the input data on the seal blank.

8. The seal printing system of claim 6, wherein the shipment information includes at least one of a tracking number, a destination name, items on a pallet, temperature requirements, and pallet weight.

9. The seal printing system of claim 6, wherein the three-dimensional printer is configured to only initiate printing of the second completed end of the seal blank upon receiving confirmation of complete entry of the shipment information into the computing system.

10. The seal printing system of claim 1, wherein the seal blank defines an elongated structure.

11. The seal printing system of claim 1, wherein the uncompleted end includes perforations or grooves for secure connection of the second completed end during printing.

12. The seal printing system of claim 1, wherein the three-dimensional printer is configured to print or emboss a unique identifier number on the blank seal.

13. A three-dimensional seal printer, comprising:
an input for receiving a seal blank having a non-functioning structure, the non-functioning structure including a first completed end and an uncompleted end incapable of interlocking with each other;
a jig configured to maintain the seal blank in a predetermined orientation and position;
one or more sensors configured to detect one or more edges of the seal blank; and
a printing section configured to print a second completed end of the seal blank, the second completed end connected to the uncompleted end such that the first and second completed ends are capable of interlocking.

14. The three-dimensional seal printer of claim 13, comprising an activation section configured to embed and activate a radio-frequency identification chip within the seal blank.

15. The three-dimensional seal printer of claim 13, comprising an activation section configured to activate a radio-frequency identification chip included within the seal blank.

16. The three-dimensional seal printer of claim 13, wherein the printing section is configured to print or emboss a unique identifier number on the blank seal.

17. A method of seal printing, comprising:
introducing a blank seal into a three-dimensional printer, the seal blank having a non-functioning structure including a first completed end and an uncompleted end incapable of interlocking with each other;
receiving input data corresponding to shipment information at a computing system having a user interface, the computing system in communication with the three-dimensional printer;
receiving input confirmation of complete entry of the shipment information into the computing system;
transmitting an indication of the confirmation from the computing system to the three-dimensional printer; and
initiating printing of a second completed end of the seal blank based on the confirmation, the second completed end connected to the uncompleted end such that the first and second completed ends are capable of interlocking.

18. The method of claim 17, further comprising:
embedding and activating with the three-dimensional printer a radio-frequency identification chip within the seal blank.

19. The method of claim 17, wherein the blank seal includes a radio-frequency identification chip and the method further comprises:
activating, with the three-dimensional printer, the radio-frequency identification chip within the seal blank.

20. The method of claim 17, wherein the blank seal includes a radio-frequency identification chip and the method further comprises:
encoding the radio-frequency identification chip using a radio-frequency identification encoder connected to the three-dimensional printer.
